(19) United States
(12) Patent Application Publication
(10) Pub. No.: US 2024/0021341 A1
(43) Pub. Date: Jan. 18, 2024

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: A-NAN YANG, Huaian (CN); HAN-RUN XIE, Huaian (CN); LU-YU CHANG, New Taipei (TW)

(21) Appl. No.: 18/113,921

(22) Filed: Feb. 24, 2023

(30) Foreign Application Priority Data
Mar. 2, 2022 (CN) 202220435084.1

(51) Int. Cl. H01B 7/02; H01B 11/00

(52) U.S. Cl. CPC H01B 7/0216; H01B 7/0266; H01B 11/002

(57) ABSTRACT

A cable includes: a pair of inner conductors; a respective first insulating layer extruded on each of the pair of inner conductors; a second insulating layer covering the first insulating layers; a shielding layer covering the second insulating layer; and an outer coating layer covering the shielding layer, wherein the second insulating layer is a braided layer.

### BACKGROUND OF THE INVENTION

### Field of the Invention

The present invention relates to a cable, and more particularly to a high-speed signal cable used to transmit high-frequency signals.

### Description of Related Arts

With the rapid development of big data and the Internet of Things, the demand for high-speed and high-frequency signal cables has grown rapidly. In the process of high-frequency and high-power signal transmission, in order to transmit the signal stably and quickly, it is necessary to improve the signal integrity performance of the cable.

China Patent No. 214624544, published on Nov. 5, 2021, discloses a cable that comprises a pair of core wires, a second insulating layer covering the core wire, a shielding layer covering the second insulating layer, and an inner layer covering the shielding layer. The core wire includes an inner conductor and a first insulating layer arranged outside the inner conductor, and ground wires are arranged between the shielding layer and the inner layer. The signal integrity performance of the cable needs to be improved. Therefore, it is necessary to provide an improved cable to overcome the deficiencies of the prior art.

### SUMMARY OF THE INVENTION

A main object of the present invention is to provide an improved cable with small size, better signal integrity performance and good high-frequency performance.

To achieve the above-mentioned object, a cable comprises: a pair of inner conductors; a respective first insulating layer extruded on each of the pair of inner conductors; a second insulating layer covering the first insulating layers; a shielding layer covering the second insulating layer; and an outer coating layer covering the shielding layer, wherein the second insulating layer is a braided layer.

Compared to prior art, the second insulating layer in the present invention is a braided layer, which can reduce the overall cable size. And the gaps between the braids are filled with air, which makes the dielectric constant smaller, thereby improving the overall SI (signal integrity) performance of the cable.

### BRIEF DESCRIPTION OF DRAWINGS

FIG. 1 is a cross-sectional view of a first embodiment of a cable of the present invention; and

FIG. 2 is a cross-sectional view of a second embodiment of the cable.

### DETAILED DESCRIPTION OF THE DRAWINGS

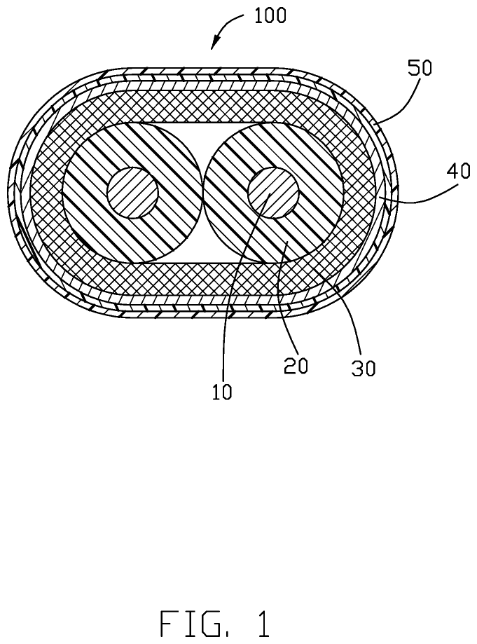

Referring to FIG. 1, it shows the first embodiment of the cable 100 of the present invention. The cable 100 includes a pair of inner conductors 10, a first insulating layer 20 covering the pair of the inner conductors 10, a second insulating layer 30 covering the first insulating layer 20, a shielding layer 40 covering the second insulating layer 30, and an outer coating layer 50. The first insulating layer 20 is respectively extruded on the outer side of the pair of the inner conductors 10.

The inner conductor 10 is selected from the group consisting of a copper inner conductor, a silver-plated copper inner conductor, and a tin-plated copper inner conductor. The first insulating layer 20 is selected from the group consisting of foamed PE (polyethylene), foamed PP (polypropylene), foamed Teflon, Solid PE, Solid PP, and Solid Teflon. The second insulating layer 30 is a braided layer made of braided wires. The material of the braided wire is selected from the group consisting of PP, PE, PET (polyethylene terephthalate), and nylon. The outer diameter of the braided wire is 0.02 to 0.2 mm. The insulating layer of the braided structure can reduce the overall size of the cable. Further, there are gaps between the braided structures and filled with air, and the dielectric constant of the insulating medium becomes smaller, thereby improving the overall SI (signal integrity) performance of the wire. Air gaps are formed between the braided layer 30 and the first insulation layer 20. The shielding layer 40 covers the braided layer 30 in a spiral winding manner or a longitudinal coating manner. The shielding layer 40 is selected from the group consisting of aluminum foil, copper foil, pure copper strip, and silver-plated copper foil. The outer coating layer 50 may be one or more layers. The outer coating layer is selected from the group consisting of foamed PE, foamed PP, foamed Teflon, solid PE, Solid PP, solid Teflon, and PET tape. In this embodiment, the number of layers for the outer coating layer is two.

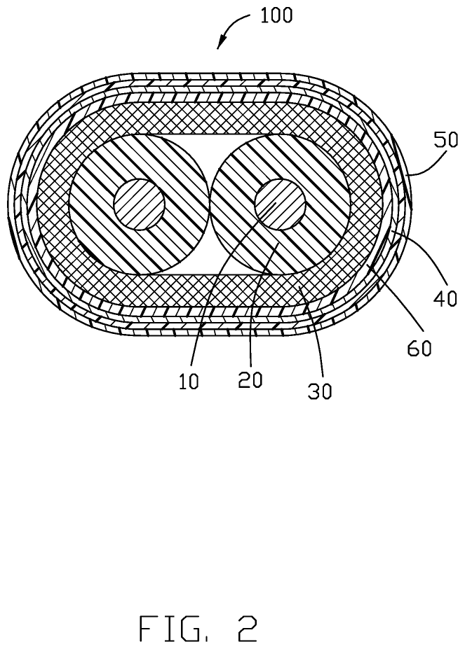

Referring to FIG. 2, it shows the second embodiment of the cable 100 of the present invention. Compared with the first embodiment, a hot melt mylar layer 60 is arranged between the braided layer 30 and the shielding layer 40 in this embodiment so as to make the overall structure of the cable more stable. And the other structure remains unchanged.

The second insulating layer in the present invention is a braided layer to reduce the overall cable size. And the gaps between the braids are filled with air, which makes the dielectric constant smaller, thereby improving the overall SI performance of the cable.

1. A cable comprising:
a pair of inner conductors;
a respective first insulating layer extruded on each of the pair of inner conductors;
a second insulating layer covering the first insulating layers;
a shielding layer covering the second insulating layer; and
an outer coating layer covering the shielding layer; wherein
the second insulating layer is a braided layer.

2. The cable as claimed in claim 1, wherein the braided layer is made of braided wire, and the material of the braided wire is selected from the group consisting of PP, PE, PET, and nylon.

3. The cable as claimed in claim 2, wherein the outer diameter of the braided wire is 0.02 to 0.2 mm.

4. The cable as claimed in claim 1, wherein there are air gaps formed between the braided layer and the first insulating layer.

5. The cable as claimed in claim 1, wherein the inner conductor is selected from the group consisting of a copper inner conductor, a silver-plated copper inner conductor, and a tin-plated copper inner conductor.

6. The cable as claimed in claim 1, wherein the shielding layer is selected from the group consisting of aluminum foil, copper foil, pure copper strip, and silver-plated copper foil.

7. The cable as claimed in claim 4, wherein the shielding layer covers the braided layer in a spiral winding manner or a longitudinal coating manner.

8. The cable as claimed in claim 1, wherein the first insulating layer is selected from the group consisting of foamed PE, foamed PP, foamed Teflon, solid PE, solid PP, and solid Teflon.

9. The cable as claimed in claim 1, wherein the outer coating layer comprises one or more layers and is selected from the group consisting of foamed PE, foamed PP, foamed Teflon, solid PE, solid PP, solid Teflon, and PET tape.

10. The cable as claimed in claim 1, wherein a hot melt mylar layer is arranged between the braided layer and the shielding layer.
